(19) United States
(12) Patent Application Publication
(10) Pub. No.: US 2025/0165929 A1
(43) Pub. Date: May 22, 2025

(54) INFORMATION PROCESSING SYSTEM, INFORMATION PROCESSING METHOD, AND PROGRAM

(71) Applicant: Communitio Corporation, Tokyo (JP)

(72) Inventors: Yasushi EBARA, Tokyo (JP); Satoru ISHIKAWA, Tokyo (JP); Kensaku SHIMADA, Tokyo (JP); Mitsutaka TAKEDA, Tokyo (JP)

(21) Appl. No.: 18/841,240

(22) PCT Filed: Feb. 24, 2023
(86) PCT No.: PCT/JP2023/006741

§ 371 Date: Aug. 23, 2024

(30) Foreign Application Priority Data
Feb. 25, 2022 (JP) 2022-027498

(51) Int. Cl. G06Q 10/107

(52) U.S. Cl. CPC G06Q 10/107

(57) ABSTRACT

An information processing system includes a storage unit and a control unit. The storage unit stores user information related to a user of a business communication tool used for communication between employees of a company, and gift right information regarding a right for the user to give a digital gift to another user as part of the communication, associating these pieces of information with each other. The control unit determines whether the user has the right based on the stored gift right information when a gift giving request to give the digital gift to the other user is received from the business communication tool used by the user, and requests a digital gift providing system to issue the digital gift if is determined that the user has the right, while also updating the gift right information in accordance with the issuance.

### TECHNICAL FIELD

The present invention relates to an information processing system, an information processing method, and a program that can provide mediation between a business communication tool and a digital gift providing system.

### BACKGROUND ART

Conventionally, technologies for giving digital gifts among users have been known.

For example, Patent Literature 1 below discloses an electronic gift selling system that: causes a user terminal to display, when receiving a request to display a predetermined web page from an application that allows a user to use financial services provided by a financial institution, the predetermined web page after the user logs into the application; causes the user terminal to display, when detecting a request to use an electronic gift purchase service on the predetermined web page, a web page that provides the electronic gift purchase service; and transmits, when detecting a request to pay for the purchase amount of the electronic gift on the web page that provides the electronic gift purchase service, a request to pay for the purchase amount to a predetermined server of the financial institution system by using authorization information for using a payment system of the financial institution system; and transmits, when settling the purchase amount, data related to the purchased electronic gift to the user terminal.

### CITATION LIST

### Patent Literature

Patent Literature 1: Japanese Patent Application Laid-open No. 2021-111106

### DISCLOSURE OF INVENTION

### Technical Problem

In the conventional electronic gift selling system as described above, users need to access a dedicated web page that provides an electronic gift purchase service. However, if an employee of a company wants to give a digital gift to another employee or an employee of another company, it is cumbersome for the employee to go through the trouble to access the above dedicated web page and perform processing for purchasing a digital gift during his/her daily work, and it is not a user-friendly system.

In view of the circumstances as described above, it is an object of the present invention to provide an information processing system, an information processing method, and a program that enables an employee of a company to easily give a digital gift during daily work.

### Solution to Problem

In order to achieve the object described above, an information processing system according to one embodiment of the present invention includes a storage unit and a control unit. The storage unit stores user information related to a user of a business communication tool used for communication between employees of a company, and gift right information regarding a right for the user to give a digital gift to another user as part of the communication, associating these pieces of information with each other. The control unit determines whether the user has the right based on the stored gift right information when a gift giving request to give the digital gift to the other user is received from the business communication tool used by the user, and requests a digital gift providing system to issue the digital gift if is determined that the user has the right, while also updating the gift right information in accordance with the issuance.

This allows the information processing system to manage gift right information of each employee, accept a gift giving request via a business communication tool routinely used by employees of a company in their work, and mediate it with the digital gift providing system, so that the employees of the company can easily give digital gifts during work. Examples of the business communication tool include, but are not limited to, groupware such as Microsoft Teams (registered trademark) and Slack (registered trademark), messaging applications, group chat applications, social networking services (SNS) for business use, and mailers. The information processing system includes one or more information processing apparatuses.

The gift right information may include at least one of the number of pieces of the digital gift that can be given by the user, an amount of money for which the digital gift can be given by the user, or a period of time for which the digital gift can be given by the user. In this case, the control unit may modify the number of pieces, the amount of money, or the period of time of the gift right information in accordance with at least one of years of service, a position, or a department of the user in the company.

This allows the information processing system to differentiate a right to give a digital gift in accordance with the status or the like of the employee in the company.

Further, the control unit may modify the number of pieces, the amount of money, or the period of time of the gift right information in accordance with the amount of money put in a predetermined account by the user.

This allows the information processing system to grant a right to an employee who wants to give a digital gift regardless of the status or the like within the company.

The control unit may display right display information indicating the at least one of the number of pieces of the digital gift that can be given, the amount of money for which the digital gift can be given, or the period of time for which the digital gift can be given on a screen of the business communication tool being used by the user.

This allows the information processing system to make the user easily understand the gift right information currently held by the employee with the business communication tool.

The control unit may update the right display information in accordance with the given digital gift when the digital gift is given based on the gift giving request from the user.

This allows the information processing system to make the user understand the change of the right display information with the business communication tool in accordance with a giving history of the digital gift.

The control unit may calculate a user evaluation value obtained by evaluating a user who has received the digital gift in accordance with the number of times the digital gift has been received.

This allows the information processing system to evaluate an employee who has received the digital gifts a higher number of times as one who has made more significant contributions to the company.

The control unit may evaluate the user who has received and given the digital gift based on a total number of times the digital gift has been received and given, and may calculate the user evaluation value accordingly.

This allows the information processing system to evaluate not only the number of times the digital gift has been received but also an action of giving a digital gift by giving a lot of thoughts to another employee, as an action having good influence in the company.

The control unit may assign weights to the user evaluation score of the user who has received the digital gift in accordance with a relationship between the user who has received the digital gift and the user who has given the digital gift.

This allows the information processing system to reflect the depth of relationships, differences in positions, and the like in the user evaluation value, for example, the relationship between the user who has given the digital gift and the user who has received the digital gift is that of colleagues or of a superior and a subordinate, or whether they are in the same department or a different department.

The control unit may increase the at least one of the number of pieces of the digital gift that can be given by the user, the amount of money for which the digital gift can be given by the user, or the period of time for which the digital gift can be given by the user in accordance with the user evaluation value of the user.

This allows the information processing system to prompt the user to perform an activity that contributes to the company, as an incentive to acquire the right to give a digital gift based on a high evaluation.

The control unit may receive the gift giving request of the digital gift together with a sending request of a message from the business communication tool, making a sending history of the message viewable to users including a sender and a recipient of the message and other users, while making a giving history of the digital gift viewable only to the sender and the recipient of the message.

This allows the information processing system to prevent each employee from hesitating in giving a digital gift because it is made public to users in the group.

An information processing method according to another embodiment of the present invention includes: storing user information related to a user of a business communication tool used for communication between employees of a company, and gift right information regarding a right for the user to give a digital gift to another user as part of the communication, associating these pieces of information with each other; and determining whether the user has the right based on the stored gift right information when a gift giving request to give the digital gift to the other user is received from the business communication tool used by the user, and requesting a digital gift providing system to issue the digital gift if is determined that the user has the right, while also updating the gift right information in accordance with the issuance.

A program according to another embodiment of the present invention causes an information processing apparatus to execute the steps of: storing user information related to a user of a business communication tool used for communication between employees of a company, and gift right information regarding a right for the user to give a digital gift to another user as part of the communication, associating these pieces of information with each other; and determining whether the user has the right based on the stored gift right information when a gift giving request to give the digital gift to the other user is received from the business communication tool used by the user, and requesting a digital gift providing system to issue the digital gift if is determined that the user has the right, while also updating the gift right information in accordance with the issuance.

### Advantageous Effects of Invention

As described above, according to the present invention, it is possible for an employee of a company to easily give a digital gift during daily work. However, such an effect does not limit the present invention.

### BRIEF DESCRIPTION OF DRAWINGS

FIG. 1 is a block diagram showing a configuration of a digital gift intermediary system according to one embodiment of the present invention.

FIG. 2 is a flowchart showing a flow of processing of granting a digital gift giving right by an intermediary server according to one embodiment of the present invention.

FIG. 3 is a sequence diagram showing a flow of digital gift transmission processing by the digital gift intermediary system according to one embodiment of the present invention.

FIG. 4 is a diagram showing an example of a timeline screen of a business communication tool displayed by the intermediary server according to one embodiment of the present invention.

FIG. 5 is a diagram showing an example of a gift giving screen (My Gift screen) displayed by the intermediary server according to one embodiment of the present invention.

FIG. 6 is a diagram showing an example of screen transition when a gift is sent on the gift giving screen displayed by the intermediary server according to one embodiment of the present invention.

FIG. 7 is a sequence diagram showing a flow of processing of granting a digital gift giving right by payment, performed by the digital gift intermediary system according to one embodiment of the present invention.

FIG. 8 is a flowchart showing a flow of user evaluation score calculation processing by the intermediary server according to one embodiment of the present invention.

FIG. 9 is a flowchart showing a flow of processing of granting a gift giving right based on a user evaluation score by the intermediary server according to one embodiment of the present invention.

### MODE(S) FOR CARRYING OUT THE INVENTION

Hereinafter, an embodiment of the present invention will be described with reference to the drawings.

### Configuration of System

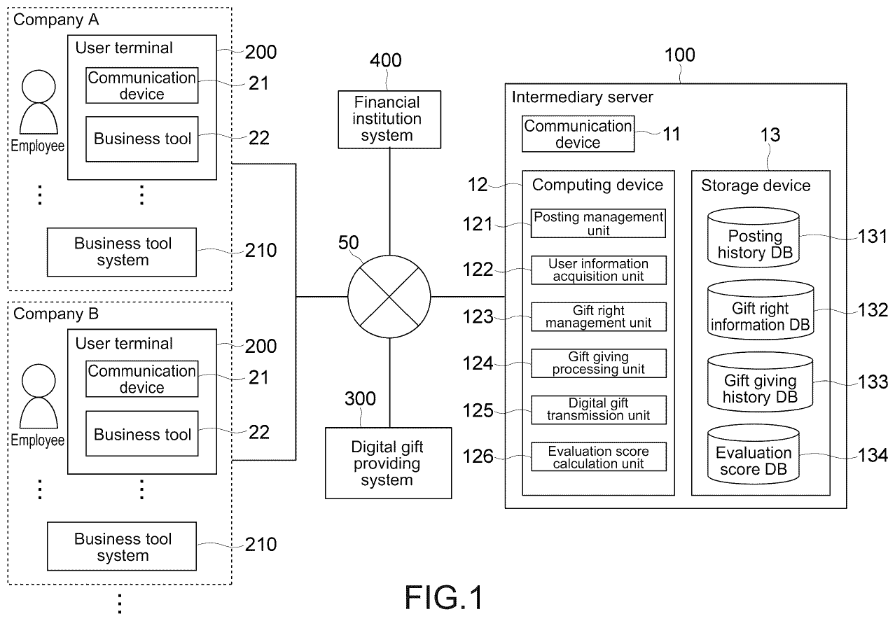

FIG. 1 is a block diagram showing a configuration of a digital gift intermediary system according to this embodiment.

As shown in the figure, this system includes an intermediary server 100, a plurality of user terminals 200 of respective companies, a digital gift providing system 300, and a financial institution system 400 that are connected to each other via a network such as the Internet 50.

The user terminal 200 is a terminal used by a user who is an employee of a company, and is, for example, a notebook personal computer (PC), a desktop PC, a smartphone, or a tablet PC. Further, the user of the user terminal 200 is assumed to have an account in a financial institution that operates the financial institution system 400.

The user terminal 200 includes a communication device 21. The communication device 21 corresponds to, for example, various modules for wireless communication, such as a network interface card (NIC) for Ethernet and a wireless local area network (LAN), and is responsible for communication processing with the intermediary server 100 or the financial institution system 400. Although not shown in the figure, the user terminal 200 also includes other hardware necessary to operate as a computer, such as a computing device, a storage device, an input device, and an output device.

A business communication tool 22 (hereinafter, also referred to simply as business tool 22), which is used by employees of each company to communicate with each other in their work, is installed on the user terminal 200.

The business communication tool 22 is, for example, groupware such as Microsoft Teams (registered trademark) or Slack (registered trademark), a messaging application, a group chat application, a social networking service (SNS) for business use, or a mailer, but is not limited thereto. In this embodiment, an example in which Microsoft Teams (registered trademark) is used as an example of the business tool 22 will be described.

The business tool 22 of this embodiment has a chat/call function, a video conference function, and a file sharing function among registered employee groups, as well as having, as a plug-in, a function of posting a thank-you card (hereinafter, referred to simply as “sticker”), which is a set of a sticker and a message to express various feelings such as gratitude, congratulations, and praise, addressed to an employee in a group. The posting history of the sticker can be viewed on the timeline.

At the time of posting the sticker, each employee can optionally give a digital gift to an employee to whom the sticker is addressed.

The business tool 22 of each user terminal 200 is managed by a business tool system 210 of each company. The business tool system 210 manages employee information such as name, position, hire date, department, and working system of each employee, as well as account information for each employee to use the business tool 22. The number of business tools 22 managed by the business tool system 210 and installed on each user terminal 200 is of course not limited to one.

The digital gift providing system 300 is a computer such as a server operated by a company that sells digital gifts, and has hardware such as a computing device, a communication device, and a storage device, though not shown in the figure.

The digital gift providing system 300 manages various digital gifts and issues a digital gift to be given by the user of the user terminal 200 to another user in response to a request from the user terminal 200.

The digital gifts are, for example, but are not limited to, digital coupons for discounts, purchases, or predetermined services for specific or unspecified products from convenience stores, restaurants, online stores, various other retailers, delivery services, travel reservation services, etc.

The intermediary server 100 is a server that provides mediation between the business tool 22 used by the user terminal 200 and the digital gift providing system 300, and manages a right for each employee of a company to give a digital gift to another employee (hereinafter, simply referred to as gift right).

The intermediary server 100 requests the digital gift providing system 300 to issue a digital gift in response to a gift giving request, which is requested from the user terminal 200 on the basis of the gift right described above, and transmits the issued digital gift or its uniform resource locator (URL) to a user as a gift recipient.

The intermediary server 100 includes various types of hardware such as a communication device 11, a computing device 12, and a storage device 13. Although not shown in the figure, the intermediary server 100 also includes other input devices (mouse, keyboard, touch panel, etc.) and output devices (e.g., display device using liquid crystal display (LCD), organic electroluminescence display (OELD), cathode ray tube (CRT), or the like).

The communication device 11 corresponds to the above-mentioned various modules for wireless communication, such as a NIC and a wireless LAN, and is responsible for communication processing with the user terminal 200 and the digital gift providing system 300.

The computing device 12 is a central processing unit (CPU) or the like, and comprehensively controls each block of the intermediary server 100 as a whole while performing various types of computing processing.

The storage device 13 is a non-volatile memory such as a hard disk drive (HDD), a flash memory (SSD; solid state drive), or other solid-state memory. The storage device 13 stores the operating system (OS), various programs, and various types of data.

In particular, in this embodiment, the storage device 13 stores programs and data for managing the gift rights of respective employee and sending digital gifts through the business tool 22 and the digital gift providing system 300.

The computing device 12 includes a posting management unit 121, a user information acquisition unit 122, a gift right management unit 123, a gift giving processing unit 124, a digital gift transmission unit 125, and an evaluation score calculation unit 126, as functional blocks for executing the processing necessary for managing the gift rights and sending the digital gifts.

Further, the storage device 13 includes a posting history database 131, a gift right information database 132, a gift giving history database 133, and an evaluation score database 134, as databases that accumulate data processed by the functional blocks of the computing device 12 or are referenced in this processing.

The posting management unit 121 stores and manages posting history information (posting date and time, posting user, posted sticker, posted message, etc.) regarding the above sticker posted by each employee, by the posting history database 131.

The user information acquisition unit 122 acquires employee information (position, department, hire date, etc.) from the business tool system 210 when gift right granting processing is executed for each employee.

The gift right management unit 123 stores and manages information (number of pieces, amount of money, expiration period, etc.) related to the gift right granted to each employee in association with the above-mentioned user information of each employee (user name, user ID, etc.) by the gift right information database 132.

The gift giving processing unit 124 requests the digital gift providing system 300 to issue a digital gift to be given on the basis of the above gift right of each employee, and stores and manages its giving history information (user as gift giver, user as gift recipient, given gift, etc.) by the gift giving history database 133.

The digital gift transmission unit 125 sends a digital gift or its URL issued by the digital gift providing system 300 to the user as a gift recipient.

The evaluation score calculation unit 126 calculates a user evaluation score for each employee on the basis of a giving/receiving history of the digital gift described above, and stores and manages it by the evaluation score database 134.

### Operation of System

Next, the operation of the digital gift intermediary system configured as described above will be described. The operation is executed by cooperation of the hardware such as the communication device 11 and the computing device 12 of the intermediary server 100, and software stored in the storage device 13. In the following description, for convenience, each of the above-mentioned functional blocks of the computing device 11 will be regarded as a main operating subject.

### Gift Right Granting Processing

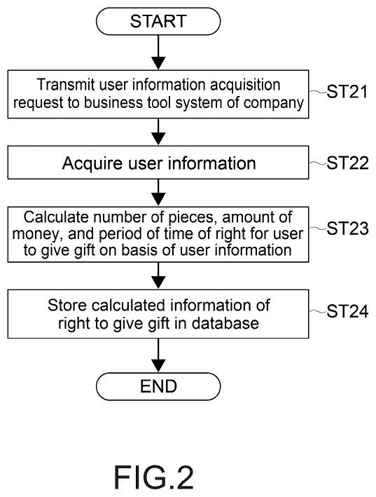

First, the gift right granting processing will be described. FIG. 2 is a flowchart showing a flow of the gift right granting processing by the intermediary server 100.

As shown in the figure, the user information acquisition unit 122 of the intermediary server 100 transmits a user (employee) information acquisition request related to the employee (user) to whom a gift right is to be granted, to a business tool system 210 of a corresponding company (Step 21). The user information acquisition request includes, for example, a user ID of a target user.

Subsequently, the user information acquisition unit 122 acquires the user information transmitted from the business tool system 210 in response to the user information acquisition request (Step 22).

The user information acquired here includes, but is not limited to, for example, information such as the year of joining the company, years of service, position (executive officer, department chief, section chief, assistant manager, etc.), job title (senior director, business unit president, director, general manager, theme leader, etc.), organization, department, etc.

Subsequently, the gift right management unit 123 of the intermediary server 100 calculates the number of pieces (number of cases), the amount of money, and a period of time (expiration period) of a gift right of a target user on the basis of the user information acquired above (Step 23).

In other words, the gift right management unit 123 sets a larger number of gift rights to be granted and a higher upper limit of the amount of usable money (unit price per gift), for users having an earlier year of joining the company or a longer years of service, or having a higher position, job title, or grade. Specifically, the gift right management unit 123 may calculate the number of pieces and the amount of money of gift rights by multiplying the preset basic number and basic amount of money of gift rights by a coefficient set according to the above-mentioned years of service, position, or the like.

Further, the gift right management unit 123 may grant gift rights only to employees belonging to a particular department (which is a case where gift rights are granted within a departmental budget).

Further, regarding the period of time of gift rights, the following three use cases are mainly conceivable.
(1) Cases where gift rights are granted at a fixed time (e.g., granted in April)
(2) Cases where gift rights are granted at a fixed timing and are granted multiple times a year (e.g., granted in April and October)
(3) Cases where there is no fixed timing for granting gift rights (granted on a case-by-case basis in accordance with campaigns and measures)

Therefore, the gift right management unit 123 starts the gift right granting processing, triggered by the arrival of the timing for granting gift rights according to (1) to (3) described above or by the occurrence of a campaign or the like.

Further, the gift right management unit 123 sets a period of time (expiration period) separately from a period of time in which the gift rights are granted. Even if a gift right has been granted to a user, it cannot be used before its expiration period (e.g., even if it has been granted in April, it can be used only from May).

Further, the gift right management unit 123 may set an expiration period of a gift right to, for example, one month after granted, uniformly for any user, or may set it to the length according to the years of service, position, or the like described above. After the expiration period elapses, the gift right expires and cannot be used.

Meanwhile, the gift right management unit 123 may set the same conditions for gift rights for all employees, regardless of the year of joining the company, position, or the like described above.

The gift right management unit 123 stores the gift right information (number of pieces, amount of money, and period of time (expiration period)) calculated above in association with the user ID and the like in the gift right information database 132 and manages it (Step 24).

The user information acquisition unit 122 and the gift right management unit 123 repeat the above processing for each target user.

Note that the number of pieces, unit price, and period of time of the gift right, and a product type of a digital gift to be granted can be modified by an input of a company's system administrator on the management screen even after the above right is granted.

In this way, for example, each company can grant gift rights to each employee as part of employee benefits and can use such gift rights as an incentive to encourage more active communication among employees on the business tool 22.

### Digital Gift Transmission Processing

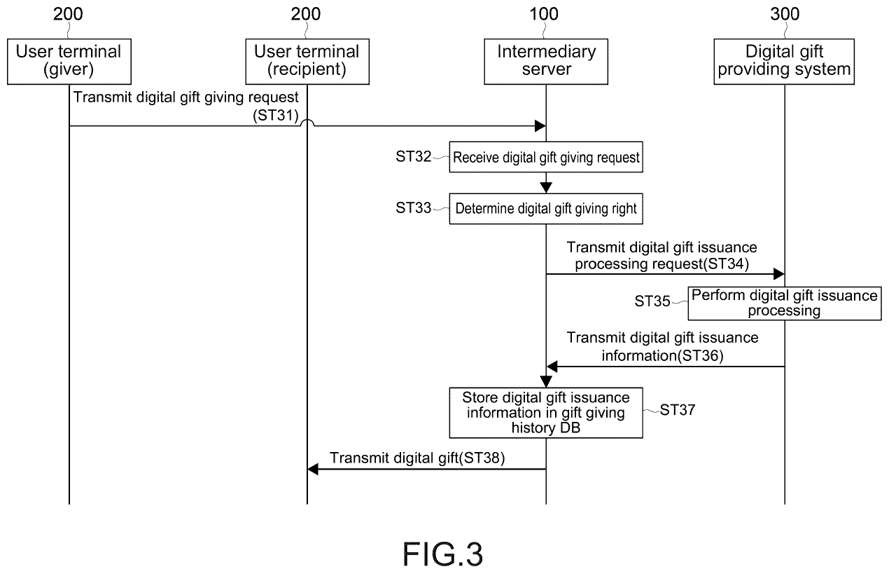

Next, the processing of transmitting (giving) the gift right described above will be described. FIG. 3 is a sequence diagram showing a flow of digital gift transmission processing by the intermediary system.

As shown in the figure, first, the user terminal 200 (giver end) transmits a digital gift giving request to the intermediary server 100 on the basis of an instruction from the business tool 22 (Step 31). The digital gift giving request includes information for specifying a digital gift requested to be given, such as an ID, a name, the amount of money, or the like of the digital gift. Further, as will be described later, the digital gift giving request is transmitted together with a request to send the sticker described above.

After receiving the digital gift giving request from the user terminal 200 (Step 32), the gift giving processing unit 124 of the intermediary server 100 references the gift right information database 132 to determine the number of pieces of a digital gift that can be given by the user who has transmitted the gift giving request, a unit price of the digital gift that can be given by the user, and a period of time for which the digital gift can be given by the user (Step 33).

As an example, if the remaining number of gift rights of the user is zero, it is determined that digital gifts cannot be given (on the basis of the number of digital gifts).

As another example, in the case of the giving request in which the remaining number of gift rights is one or more but the unit price is above a set price (for example, 500 yen), it is determined that digital gifts cannot be given (on the basis of the unit price).

As another example, in the case of the giving request in which the remaining number of gift rights is one or more and the unit price is within the range of a set price (for example, 500 yen), but digital gifts can be given from the next month, it is determined that digital gifts cannot be given (on the basis of the period of time; digital gifts cannot be given before expiration period).

As another example, in the case of the giving request in which the remaining number of gift rights is one or more and the unit price is within the range of a set price (for example, 500 yen), but the period of time in which digital gifts are given has expired in the last month, it is determined that digital gifts cannot be given (on the basis of the period of time; digital gifts cannot be given after the expiration period).

As another example, in the case of the giving request in which the remaining number of gift rights is one or more and the unit price is within the range of a set price (for example, 500 yen), and the period of time in which digital gifts can be given is satisfied, it is determined that digital gifts can be given.

If it is determined that a gift can be given, the gift giving processing unit 124 transmits a digital gift issuance processing request including the above ID of the digital gift or the like to the digital gift providing system 300 (Step 34). If it is determined that a gift cannot be given, the gift giving processing unit 124 notifies the user terminal 200 of the fact that a gift cannot be given, along with the reason for the determination.

When receiving the digital gift issuance processing request from the intermediary server 100, the digital gift providing system 300 performs digital gift issuance processing (Step 35). In other words, the digital gift providing system 300 generates code information or the like for using a digital gift corresponding to the digital gift ID included in the digital gift issuance processing request at a store or the like, and executes the payment for the corresponding amount using a predetermined method. The digital gift providing system 300 then transmits digital gift issuance information to the intermediary server 100 (Step 36).

When receiving the digital gift issuance information from the digital gift providing system 300, the gift giving processing unit 124 stores it in the gift giving history database 133 (Step 37). At the same time, the gift right management unit 123 updates the gift right information of the gift-giving user, reducing their gift rights by one.

The digital gift transmission unit 125 then transmits the digital gift to the user terminal 200 (recipient end) on the basis of the digital gift issuance information (Step 38).

Here, a user interface for digital gift giving processing on the business tool 22 will be described.

As described above, the posting history of the sticker can be viewed as a timeline on the business tool 22, and a user interface for a digital gift giving request is also provided on this timeline.

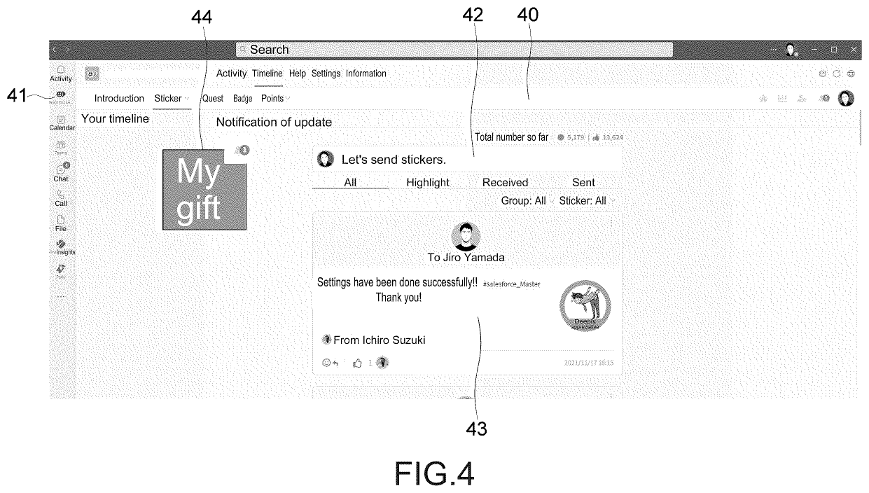

In other words, as shown in FIG. 4, for example, icons for selecting tabs of various screens are provided at the left end on the business tool 22. When a sticker icon 41 is selected from those icons, a timeline screen 40 of the sticker posting history is displayed as shown in the figure.

On the timeline screen 40, a sticker posting history 41 is listed vertically. Further, a sticker posting button 42 for newly posting a sticker is displayed on the upper part, and in addition thereto, a My Gift icon 43, for which a link to a My Gift page that displays information regarding a digital gift of each user is set, is displayed in the upper left of the screen, for example.

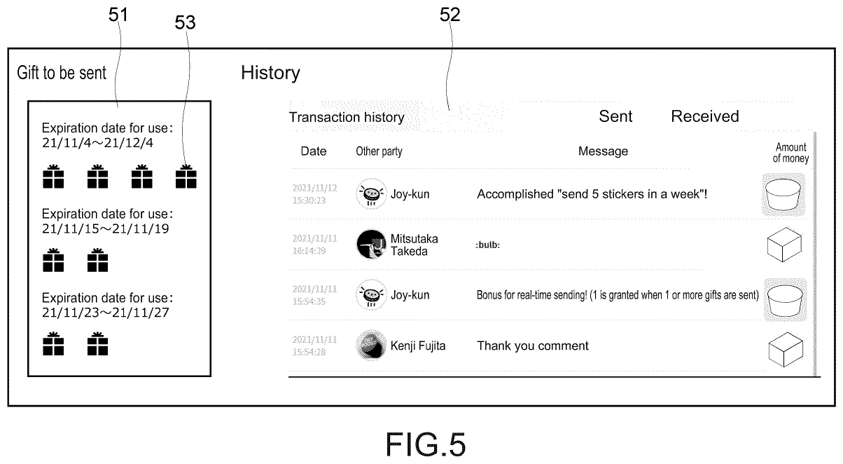

When the user presses down the My Gift icon 43, the My Gift page as shown in FIG. 5 is displayed.

As shown in the figure, the My Gift page includes gift right display information 51 showing gift rights of each user, and gift history information 52 showing a digital gift giving/receiving history so far.

The gift right display information 51 indicates the number of gift rights by the number of gift icons 53, for example, for each of the periods of time (expiration periods) of the gift rights granted to each user. The unit price of the gift right for each user is indirectly known to the user because when a list of digital gifts that can be given (described later) is displayed, only digital gifts that are less expensive than the above unit price are displayed. Of course, the unit price of the gift right of the user may be displayed on the My Gift page.

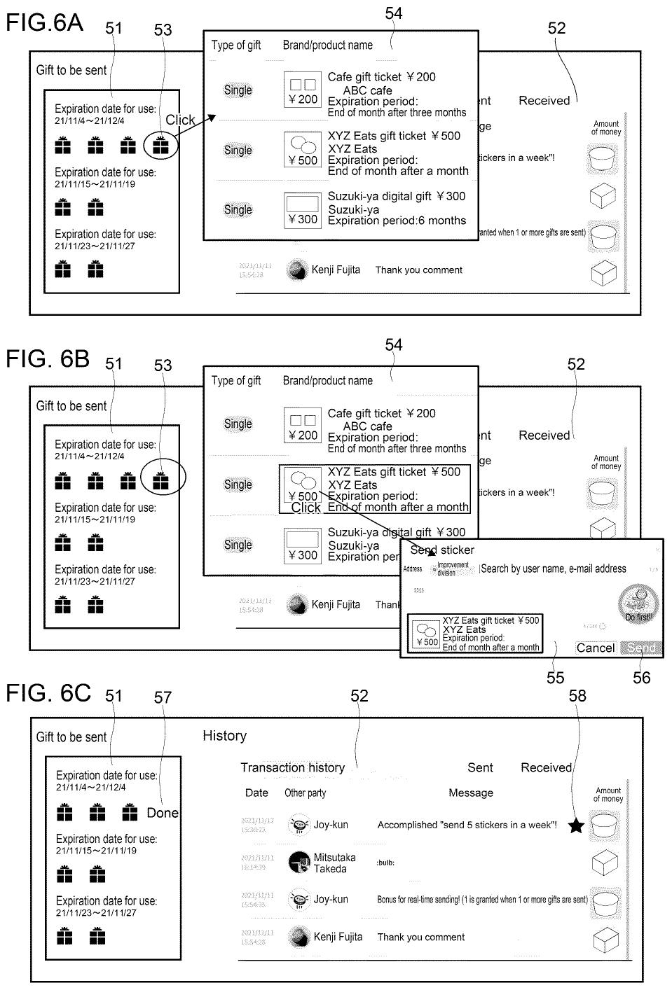

FIG. 6 is a diagram showing an example of the screen transition when the digital gift giving processing is performed from the My Gift page.

As shown in A of the figure, when the user of the user terminal 200 clicks on any of the gift icons 53 in the gift right display information 51 on the My Gift page, a list 54 of digital gifts that can be given is displayed. The digital gift list 54 includes gift fields that each include, for example, a product name, a store name, the amount of money, a photo, etc. of a digital gift and are arranged vertically, for example.

Subsequently, as shown in B of the figure, when the user selects one of the gifts from the digital gift list 54 by clicking, a sticker sending screen 55 is displayed. The sticker sending screen 55 displays information of the digital gift selected above, together with an input field for a message to be sent with the sticker.

Subsequently, when the user selects a sticker, inputs a message, and clicks a “Send” button 56 on the sticker sending screen 55, a digital gift issuance request is transmitted to the digital gift providing system 300 as described above, and the digital gift is transmitted to the user terminal 200 on the recipient end.

Subsequently, as shown in C of the figure, when the transmission of the digital gift is completed, the gift right management unit 123 updates the gift right display information 51. In other words, the gift right management unit 123 deletes the corresponding gift icon 53 displayed in the gift right display information 51 and displays an image such as “Done” instead. The gift right management unit 123 may delete only the gift icon 53 without displaying a substitute image. This makes it easy for the user to know that the user's gift rights have been reduced by one. Further, the posting management unit 121 posts a new sending history of the sticker with the digital gift on the gift history information 52.

In addition, on the gift history information 52 on the My Gift page of the business tool 22 of the user terminal 200 on the recipient end, a new receiving history of the above sticker sent with the digital gift is displayed, and a reaction button with which a reaction to the digital gift can be made is also displayed. When the user on the recipient end clicks the reaction button, the reaction is transmitted to the intermediary server 100 as reaction information. As shown in C of the figure, the posting management unit 121 displays a reaction icon 58 indicating the reaction of the user on the recipient end to the given digital gift, on the sticker sending history in the corresponding gift history information 52.

Further, the posting management unit 121 manages the posting history of the sticker so that it is viewable on the timeline by users in the group of the business tool 22, including the sender and the recipient of the sticker and other users. In contrast, the history of the digital gift exchanges is managed to be viewable only on the gift history information 52 of the My Gift page of each user involved in giving or receiving the digital gift, and not viewable by the other users in the group. This prevents employees from hesitating to give a digital gift due to concerns about public visibility within the group.

### Gift Right Granting Processing by Payment

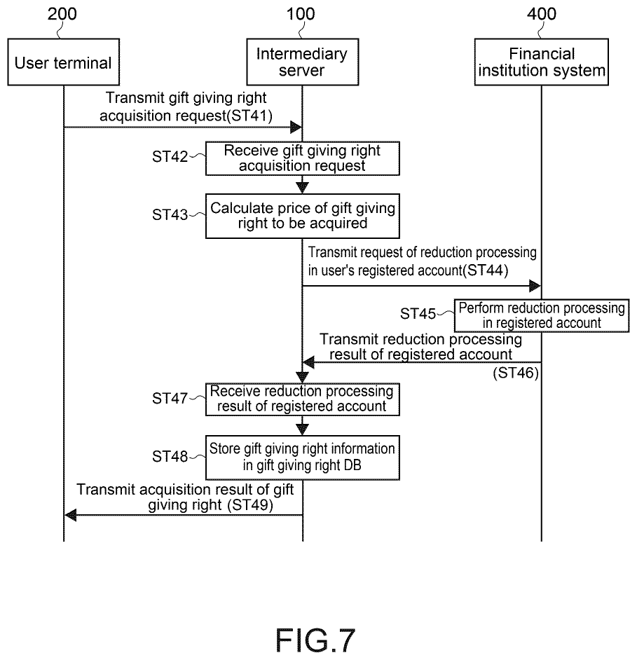

In the example described above, the number of pieces and the unit price of gift rights differ depending on each employee's years of service, position, or the like. In addition to the above, it is also possible for each employee to increase the number of gift rights by payment. FIG. 7 is a sequence diagram showing a flow of processing of granting a digital gift giving right by payment, performed by the digital gift intermediary system.

As shown in the figure, first, the user terminal 200 transmits a gift right acquisition request to the intermediary server 100 via, for example, a gift right acquisition button (not shown) provided to the My Gift page of the business tool 22 (Step 41). The gift right acquisition request includes, for example, information indicating the unit price and the number of gift rights (e.g., 500 yen/piece ×4 pieces) that the user want to acquire.

When receiving the gift right acquisition request (Step 42), the gift right management unit 123 of the intermediary server 100 calculates the price (amount to be paid) of the gift giving right that the user wants to acquire (Step 43). In the example described above, the price is calculated to be 500×4=2000 yen.

Subsequently, the gift right management unit 123 transmits to the financial institution system 400 a request to perform processing of reducing the calculated amount of money from the registered account of the user who has transmitted the above acquisition request (Step 44).

When receiving the reduction processing request, the financial institution system 400 performs the above-mentioned reduction processing in the user's registered account (Step 45) and transmits a reduction processing result to the intermediary server 100 (Step 46).

When receiving the reduction processing result (Step 47), the gift right management unit 123 stores corresponding gift giving right information in the gift giving right database 132 (Step 48). In the example described above, the gift right information is updated to increase four pieces of the gift right of 500 yen in accordance with the above amount paid of 2000 yen. Further, the gift right management unit 123 displays four new gift icons on the gift right display information 51 of the My Gift page.

Note that, for the gift rights granted on the basis of payment, a period of time (expiration period) is not set, or a longer period of time (e.g., several months, a year, etc.) than the period of time of gift rights granted free of charge by the company (e.g., several weeks, a month, etc.) is set.

The gift right management unit 123 then transmits a gift right acquisition result, indicating that the gift right has been acquired, to the user terminal 200 that has transmitted the acquisition request (Step 49).

In such a manner, the number of pieces, unit price, or period of time of the gift right information is modified in accordance with the amount of money put in the registered account of the user. Thus, regardless of the status or the like of an employee in the company, an employee who wants to give a digital gift to another employee can be granted a gift right, for example, even if the employee have used up the gift rights granted free of charge by the company.

Here, the gift right management unit 123 separately treats the gift rights granted free of charge by the company and the gift rights granted by payment of the employee and displays both of them (the gift icons 53 thereof) while distinguishing their regions on the My Gift page. On the other hand, instead, the gift right management unit 123 may accept payment by the employee so as to upgrade the gift rights granted free of charge (e.g., increase the amount of money or prolong the period of time).

Further, the amount of money put by the employee may be paid from the registered account (or credit card) that each employee has in the financial institution system 400 as described above, or it may be deducted from the employee's salary.

Further, the gift right management unit 123 may also set a Wallet for electronic money for each employee, separately from the above-mentioned registered account, and allow the employee to put money in the Wallet and check the remaining amount of money therein on the My Gift page.

In this case, assuming that the employee puts, for example, 1800 yen in the Wallet, 1800 yen is displayed in the remaining amount of money in the Wallet on the My Gift page. In this situation, when the employee requests to purchase gift rights of, for example, 500 yen/piece×3 pieces=1500 yen, 1500 yen will be deducted from the Wallet. In the payment region of the gift right display information 51 on the My Gift page, three gift icons 53 indicating the three gift rights purchased are displayed, and 300 yen is displayed as the remaining amount of money in the Wallet. Note that, in the Wallet, money may be put not only by the employee, but also, for example, the company may put a predetermined amount of electronic money periodically as part of employee benefits. Further, points may be put rather than as electronic money, and the conversion rate between the points and the electronic money may be set, so that each employee may purchase gift rights with the points.

### User Evaluation Score Calculation Processing

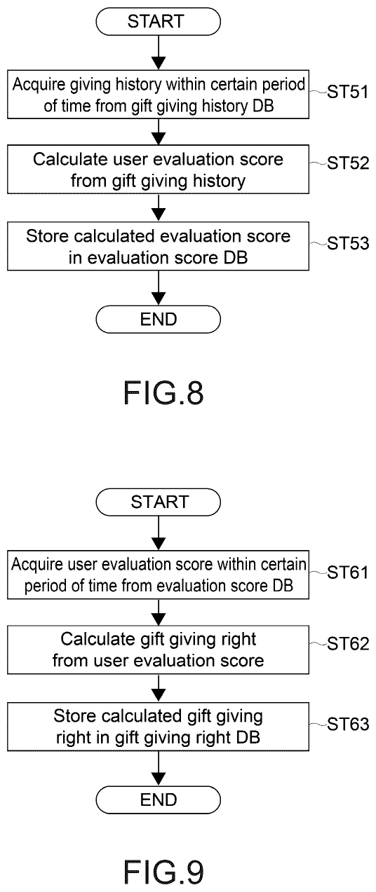

In this embodiment, the intermediary server 100 can evaluate users on the basis of traffic data of the above digital gift. Specifically, the intermediary server 100 calculates a user evaluation score obtained by evaluating a user who has received a digital gift in accordance with the number of times the digital gift has been received. FIG. 8 is a flowchart showing user evaluation score calculation processing by the intermediary server 100.

As shown in the figure, the evaluation score calculation unit 126 of the intermediary server 100 first acquires the giving history within a certain period of time (e.g., six months, one year, etc.) of a target user from the gift giving history database 133 (Step 51). The timing of such acquisition is, for example, but not limited to, at the end of a half year, at the end of a fiscal year, etc.

Subsequently, the evaluation score calculation unit 126 calculates a user's evaluation score from the acquired gift giving history (Step 52).

The score calculation unit 126 then stores the calculated user evaluation score in the evaluation score database 134 (Step 53).

The evaluation score calculation unit 126 repeats the above processing for each target user.

The details of the evaluation score calculation processing will be described here.

The data to be managed in calculating the evaluation score is how many digital gifts have been given from which user to which user. These pieces of data may be reset at every certain period of time (e.g., reset at semiannual intervals, reset at end of year, etc.) or may be accumulated (in either case, the data itself in the gift giving history database 133 is not deleted).

The number of cases where each digital gift has been given is regarded as a result of good behaviors, such as “supporting others” or “contributing to the organization”, performed by the recipient of the digital gift. Further, the recipient's invisible characteristics such as “cooperativeness”, “social skills”, “popularity (virtue)”, and the like are regarded as being behind such behaviors.

Therefore, the evaluation score calculation unit 126 may analyze (imply and evaluate) that a user who has received more digital gifts is a person who performs more favorable behaviors and characteristics, and may set a higher evaluation score for a user who has received more digital gifts, while assigning different weights according to the items of favorable behaviors and characteristics, not simply performing evaluation on the basis of the number of gifts received.

For example, if it can be determined that a digital gift is given because of a support for another person, the number of gifts given may be multiplied by a factor of 0.8. On the other hand, if it can be determined that a digital gift is given because of the popularity of that person, the number of gifts given may be multiplied by a factor of 0.3.

This is because the behavior of supporting others is an evaluation item that is obvious as a fact, whereas the popularity is not an evaluation item that can be immediately identified. Thus, the coefficient in the latter case is made smaller such that the evaluation score is less likely to be accumulated as a user evaluation score in the latter case than in the former case. In other words, the coefficients can be set such that user evaluation scores are less likely to be accumulated for evaluation items that should be evaluated more carefully.

Here, the behavior and characteristics, such as whether the digital gift has been given for supporting others or for the popularity, can be determined by referring to and analyzing the stickers and messages that have been sent together with the digital gift.

Further, even when a certain user has received a digital gift, if the digital gift is based on a gift right purchased by the giver by payment, the evaluation score calculation unit 126 may calculate a higher user evaluation score than when the digital gift is based on a gift right granted to the giver free of charge by the company (e.g., a gift based on a gift right granted free of charge is weighted with 1, while a gift based on a gift right granted by payment is weighted with 2).

In addition, the evaluation score calculation unit 126 may assign weights to the user evaluation score of a user who has received a digital gift in accordance with the relationship between the user who has received the digital gift and the user who has given the digital gift.

In other words, the evaluation score calculation unit 126 may vary the above coefficient depending on, for example, whether the user who has given the digital gift is a superior, subordinate, or colleague or in the same department or a different department with respect to the user who has received the digital gift, on the basis of the information on the position, years of service, department, or the like of the giver and the recipient of the digital gift.

More specifically, for example, it is possible to set a higher coefficient (i.e., a higher evaluation) if the sender of the digital gift is an immediate superior who always takes care of the user who has received the digital gift, set a slightly lower coefficient if the sender is a superior in a different department, or set a higher coefficient than the case where the sender is a superior or subordinate if the sender is a colleague.

Those items related to the user's behavior and characteristics can be set discretionally, and the coefficients can also be set discretionally. Further, the evaluation score calculation unit 126 may display a user's own user evaluation score on the My Gift page of each user or may allow a company's system administrator to view the user evaluation scores of all employees.

### Gift Right Granting Processing Based on Evaluation Score

The intermediary server 100 can also return the above calculated user evaluation score as a gift right. In other words, the intermediary server 100 may increase at least one of the number of pieces of digital gifts that can be given by each user, the amount of money for which digital gifts can be given by each user, or the period of time for which digital gifts can be given by each user, in accordance with the user evaluation score. FIG. 9 is a flowchart showing a flow of gift right granting processing based on the user evaluation score by the intermediary server 100.

As shown in the figure, first, the gift right management unit 123 of the intermediary server 100 acquires the user evaluation score within a certain period of time (half year, one year, etc.) for a target user from the evaluation score database 134 (Step 61).

Subsequently, the gift right management unit 123 then calculates the gift right from the acquired user evaluation score (Step 62).

The gift right management unit 123 then stores the calculated gift giving right information in the gift right information database 132 and updates the gift right display information 51 on the above My Gift page (Step 63).

The gift right management unit 123 repeats the above processing for each target user.

The details of gift right calculation processing based on the user evaluation score described above will be described here.

The gift right management unit 123 may set a threshold value for each of the user's favorable behaviors and characteristics to be evaluated as the user evaluation score, and may grant a gift right when the user evaluation score exceeds the threshold value (e.g., one gift right is granted to each of the favorable behaviors and characteristics for every 20 points of user evaluation score).

Further, a gift right may be granted every time the threshold value is exceeded (one gift right is granted at 20 points of the user evaluation score, and two gift rights are granted at 40 points thereof). Alternatively, a plurality of threshold values may be set, and a corresponding gift right may be granted when the user evaluation score exceeds each threshold value (one gift right is granted at 20 points, ten gift rights are granted at 100 points, for example).

Further, the gift right management unit 123 may set a threshold value for a total value of favorable behaviors and characteristics and grant a gift right when the user evaluation score exceeds the threshold value.

Note that, as for the gift right to be granted based on the user evaluation score, a limit number of grant may be set (e.g., up to 20 gift rights in a year per user).

Further, instead of a gift right granting method using the threshold value, the gift right management unit 123 may treat the user evaluation value of each user directly as points and make a gift right and the points exchangeable at every predetermined points (e.g., one gift right can be exchanged with 20 points) on the My Gift page in response to the request of the user. In this case as well, a limit number of exchangeable gift rights may be set (e.g., up to 20 gift rights in a year per user).

Further, the gift right management unit 123 may be capable of exchanging a plurality of gift rights having different unit prices, as well as the number of pieces, in accordance with the above-mentioned points (250 yen×1 gift right granted with 20 points, 250 yen×2 gift rights or 500 yen×1 gift right granted with 40 points).

As described above, the intermediary server 100 returns the user evaluation score to the user as the gift right, and thus can prompt the user to perform an activity (favorable behavior, characteristics) that contributes to the company, as an incentive to acquire gift rights on the basis of a high evaluation.

### Conclusion

As described above, according to this embodiment, the intermediary server 100 manages the gift right information of each employee of the company, accepts a gift giving request for another employee via a business communication tool routinely used by the employee of the company in their work, and mediates the gift giving request with the digital gift providing system 400, so that the employee can easily give a digital gift during work.

### MODIFIED EXAMPLES

The present invention is not limited to the embodiment described above, and various modifications may be made thereto without departing from the gist of the present invention.

In the embodiment described above, the example in which the digital gift is sent together with the sticker has been shown, but the digital gift may be capable of being given independently of the sticker.

In the embodiment described above, the intermediary server 100 calculates a user evaluation score for an employee who has received a digital gift in accordance with the number of times the digital gifts have been received. However, the intermediary server 100 may assign a user evaluation score to the employee by evaluating an action of giving a gift with respect for another person, not only when the employee has received another digital gift but also when the employee gives a digital gift to another employee.

In other words, the intermediary server 100 may evaluate the user who has received the digital gift and has given the digital gift in accordance with the total number of the cases where the digital gift has been received and the cases where the digital gift has been given, to calculate the user evaluation scores. In this case, either the number of cases where the digital gift has been received or the number of cases where the digital gift has been given may be multiplied by a coefficient for weighting.

Further, in this case, similarly as described above, the user evaluation score in the case where the sender gives a digital gift on the basis of a gift right acquired by payment by himself/herself may be set to be higher than the user evaluation score in the case where the sender gives a digital gift on the basis of a gift right granted free of charge by the company.

In the embodiment described above, the example in which each employee selects and gives any one of digital gifts based on the gift right granted to him/herself has been shown. However, it is also possible to give a gift in which a plurality of digital gifts is boxed.

In this case, the gift giving processing unit 124 can set gifts to be boxed among a plurality of digital gifts in advance (e.g., three gifts) and display the box as one of the options on the digital gift list 54; if the user selects the boxed gift and transmits a giving request, can display any one of the gifts in the boxed gift so as to be selectable by a user on the recipient end; and if the user on the recipient end selects any one of the gifts in the boxed gift, can treat the processing of giving the selected digital gift as being completed.

Further, instead of boxing a predetermined number of digital gifts in advance, the user on the giver end may perform a predetermined “boxing” operation (e.g., click a “boxing button” after selecting a plurality of digital gifts) on the digital gift list 54, so that the giver end can discretionally box a plurality of digital gifts and give the gifts in boxed form each time.

In the embodiment described above, the intermediary server 100 analyzes the traffic of the digital gift in the form of calculating the user evaluation score. As another traffic analysis, the intermediary server 100 may visualize the sending route of the digital gift as a network diagram so as to be viewable on the digital tool 22 (or only by the system administrator).

In other words, the intermediary server 100 generates a network diagram showing, as a link, from which node to which node a digital gift is sent on the basis of the gift giving history database 134, with the entire organization of the company or a subset obtained by segmenting the entire organization being set as a population and with an employee belonging to the population being set as a node. Segmentation can be discretionally performed by a system administrator. Further, in the network correlation diagram, it may be possible to identify a node having “mediation centrality” in the population and display such a node as distinguished from other nodes.

In the embodiment described above, the intermediary server 100 directly transmits the digital gift issued by the digital gift providing system 300 to the user terminal 200 on the recipient end. However, the intermediary server 100 may request the digital gift providing system 300 to transmit the URL of the digital gift instead of performing the digital gift issuance processing at the time of sending the sticker, acquire the URL, and transmit the digital gift to the user terminal 200 on the recipient end by, for example, e-mail or other communication means.

In this case, the sent sticker is accumulated as the history in the gift history information 52 of the My Gift page. Further, separately from the My Gift page, the sticker is also reflected on the timeline 42 of the sticker, but the information regarding the digital gift is not displayed there.

The intermediary server 100 described in the above embodiment is illustrated as a single server but may be configured as a system in which the functions thereof are distributed among a plurality of servers or information processing apparatuses.

In the inventions described in the scope of claims of the present application, the invention described as an “information processing method” is one in which at least one apparatus such as a computer automatically performs each step by information processing performed by software, and is not performed by a human using an apparatus such as a computer. In other words, the “information processing method” is an information processing method performed by computer software and is not a method by a human operating a computational tool called a computer.

### REFERENCE SIGNS LIST

11 communication device
12 computing device
13 storage device
51 gift right display information
52 gift history information
53 digital gift icon
54 digital gift list
100 intermediary server
121 posting management unit
122 user information acquisition unit
123 gift right management unit
124 gift giving processing unit
125 digital gift transmission unit
126 evaluation score calculation unit
131 posting history database
132 gift right information database
133 gift giving history database
134 evaluation score database
200 user terminal
300 digital gift providing system
400 financial institution system

1. An information processing system, comprising:
a storage unit that stores user information related to a user of a business communication tool used for communication between employees of a company, and gift right information regarding a right for the user to give a digital gift to another user as part of the communication, associating these pieces of information with each other; and
a control unit that
determines whether the user has the right based on the stored gift right information when a gift giving request to give the digital gift to the other user is received from the business communication tool used by the user, and
requests a digital gift providing system to issue the digital gift if is determined that the user has the right, while also updating the gift right information in accordance with the issuance.

2. The information processing system according to claim 1, wherein
the gift right information includes at least one of the number of pieces of the digital gift that can be given by the user, an amount of money for which the digital gift can be given by the user, or a period of time for which the digital gift can be given by the user, and
the control unit modifies the number of pieces, the amount of money, or the period of time of the gift right information in accordance with at least one of years of service, a position, or a department of the user in the company.

3. The information processing system according to claim 1, wherein
the gift right information includes the at least one of the number of pieces of the digital gift that can be given by the user, the amount of money for which the digital gift can be given by the user, or the period of time for which the digital gift can be given by the user, and
the control unit modifies the number of pieces, the amount of money, or the period of time of the gift right information in accordance with the amount of money put in a predetermined account by the user.

4. The information processing system according to claim 2, wherein
the control unit displays right display information indicating the at least one of the number of pieces of the digital gift that can be given, the amount of money for which the digital gift can be given, or the period of time for which the digital gift can be given on a screen of the business communication tool being used by the user.

5. The information processing system according to claim 4, wherein
the control unit updates the right display information in accordance with the given digital gift when the digital gift is given based on the gift giving request from the user.

6. The information processing system according to claim 2, wherein
the control unit calculates a user evaluation value obtained by evaluating a user who has received the digital gift in accordance with the number of times the digital gift has been received.

7. The information processing system according to claim 6, wherein
the control unit evaluates the user who has received and given the digital gift based on a total number of times the digital gift has been received and given, and calculates the user evaluation value accordingly.

8. The information processing system according to claim 6, wherein
the control unit assigns weights to the user evaluation score of the user who has received the digital gift in accordance with a relationship between the user who has received the digital gift and the user who has given the digital gift.

9. The information processing system according to claims 6, wherein
the control unit increases the at least one of the number of pieces of the digital gift that can be given by the user, the amount of money for which the digital gift can be given by the user, or the period of time for which the digital gift can be given by the user in accordance with the user evaluation value of the user.

10. The information processing system according to claim 1, wherein the control unit
receives the gift giving request of the digital gift together with a sending request of a message from the business communication tool, making a sending history of the message viewable to users including a sender and a recipient of the message and other users, while making a giving history of the digital gift viewable only to the sender and the recipient of the message.

11. An information processing method, comprising:
storing user information related to a user of a business communication tool used for communication between employees of a company, and gift right information regarding a right for the user to give a digital gift to another user as part of the communication, associating these pieces of information with each other; and
determining whether the user has the right based on the stored gift right information when a gift giving request to give the digital gift to the other user is received from the business communication tool used by the user, and requesting a digital gift providing system to issue the digital gift if is determined that the user has the right, while also updating the gift right information in accordance with the issuance.

12. A non-transitory computer-readable recording medium storing a program that causes an information processing apparatus to execute the steps of:
storing user information related to a user of a business communication tool used for communication between employees of a company, and gift right information regarding a right for the user to give a digital gift to another user as part of the communication, associating these pieces of information with each other; and
determining whether the user has the right based on the stored gift right information when a gift giving request to give the digital gift to the other user is received from the business communication tool used by the user, and requesting a digital gift providing system to issue the digital gift if is determined that the user has the right, while also updating the gift right information in accordance with the issuance.

13. The information processing system according to claim 2, wherein
the gift right information includes the at least one of the number of pieces of the digital gift that can be given by the user, the amount of money for which the digital gift can be given by the user, or the period of time for which the digital gift can be given by the user, and
the control unit modifies the number of pieces, the amount of money, or the period of time of the gift right information in accordance with the amount of money put in a predetermined account by the user.
